(19) United States
(12) Patent Application Publication
(10) Pub. No.: US 2004/0027317 A1
(43) Pub. Date: Feb. 12, 2004

(54) Method for scanning display panel with variable number of encoding bits of luminance

(76) Inventor: Alexis Seguin, Grenoble (FR)

Correspondence Address: Joseph S Tripoli, Thomson Multimedia Licensing Inc, Patent Operations CN 5312, Princeton, NJ, 08543-0028, US

(21) Appl. No.: 10/416,353

(22) PCT Filed: Oct. 2, 2001
(86) PCT No.: PCT/FR01/03037

(30) Foreign Application Priority Data
Nov. 8, 2000 (FR) 00/14304

(51) Int. Cl. G09G 3/28

(52) U.S. Cl. 345/63

(57) ABSTRACT

Method in which the control signals are staggered over a succession of frames T, each frame comprising at least one subframe ST1, ST2, etc. composed of subfields.

The number of subframes ST1, ST2, etc. constituting a frame is varied during display.

The invention relates to a method of driving an image display panel comprising a matrix of luminous elements or pixels, each capable of emitting a primary colour, which method is intended for controlling the brightness of each of these pixels; more specifically, each pixel of the panel is located at the intersection of an electrode belonging to a first array and of an electrode or of a pair of electrodes belonging to another array; the method is suitable for applying voltages between these electrodes suitable for activating or not activating light emission at each of these intersections; the invention applies notably to plasma panels.

In general, in a display panel of this type the electrodes of the address array are parallel and placed vertically, while the electrodes or pairs of electrodes which are also parallel, of the other array are placed horizontally; the vertical electrodes are called column electrodes and the horizontal electrodes or pairs of electrodes are called row or line electrodes or pairs of row or line electrodes.

The electrical voltages applied to these electrodes are generally controlled:

in the case of the columns, simultaneously over all the columns so that voltage signals specific to each column are addressed simultaneously with the columns of the panel; thus, addressing of the columns is selective since each column receives a signal specific to each address sequence;

in the case of the lines, line by line, or groups of lines by groups of lines, so that suitable different signals are assigned in succession to each line or group of lines.

A method of driving an image display panel therefore comprises the scanning of all of the lines or groups of lines for the complete display of an image; the scan time or frame time must remain less than or equal to the image refresh period so as to ensure the necessary synchronization with the image source; this refresh time corresponds, for example, to the scanning of a half-screen in the case of the “dual scan” mode, corresponds to 20 ms in the conventional case of “50 Hz” television in Europe, and corresponds to 16.6 ms in the conventional case of “60 Hz” television in the United States of America.

For certain display panels, such as plasma panels, it is not possible for the instantaneous amount of light emitted by each pixel to be modulated sufficiently; in order to modulate the “apparent” brightness of a pixel, that is to say the brightness integrated over an integration period by the eye of about twenty milliseconds, it is known to vary the duration of emission of each pixel during this period; the duration of illumination of the pixels of a line or a group of lines is then divided into a predetermined number n of subfields SF₀, SF₁, . . . , SF₍ᵢ₎, . . . , SF₍ₙ₋₁₎ of fixed or variable duration T_{SF}; then, for each pixel of the panel, the number or the combination of subfields lit is varied over the duration of a frame according to the brightness of the corresponding point in the image to be displayed; the sum of the durations

$${\sum }_{0}^{n - 1} {T}_{SF ( i )}$$

of the various subfields SF₀, SF₁, . . . , SF₍ᵢ₎, . . . , SF₍ₙ₋₁₎ must remain less than the refresh period of the image to be displayed; the addressing method must be suitable for being capable of addressing all the subfields at all the lines or all the groups of lines over the duration of a frame; the number and the duration of the subfields are tailored in a manner known per se in order to obtain a large enough number of possible subfield combinations capable of forming a sufficiently precise brightness gradation and to limit display defects, especially “contouring” defects.

The brightness that a pixel must display is then coded in a manner known per se as a video word (b₀, b₁, . . . , bᵢ, bₙ₋₁) of n bits, the value of each bit bᵢ, namely 0 or 1, corresponding to this pixel being lit or not lit during the corresponding subfield SF₍ᵢ₎.

In plasma panels, each pixel corresponds to a discharge cell of the panel; to address the cells, each subfield for a line or group of lines generally has an address period Tₐ for lighting the cells or not, and a sustain period Tₛ for keeping the cell lit for a predetermined activation time Tₛ specific to the subfield, the cell being kept lit only if it was activated during the preceding address period Tₐ—the relative duration Tₛ of a subfield SF₍ᵢ₎ is generally called the “weight” of the subfield; the total duration T_{SF} of a subfield is given by: T_{SF}≧Tₐ+Tₛ.

Two types of methods of addressing matrix display panels are conventionally used:

in the first method, called ADS (Address and Display Separated), the group of lines addressed simultaneously comprises all of the lines of the panel; one advantage of this method is that it makes it possible to independently control the sequencing of the address signals during the panel address period and that of the sustain signals during the panel sustain period; there is no risk of addressing interference between the lines since the subfields follow one another for the entire panel according to the sequences: . . . , address period T_{a-SF(i)}-sustain period T_{g-SF(i)} of a subfield SF₍ᵢ₎-address period T_{a-SF(i+1)}-sustain period T_{s-SF(i+1)} of the next subfield SF₍ᵢ₊₁₎, etc.;

in the second method, called AWD (Address While Display), the group of lines addressed simultaneously comprises at most half of the lines of the panel; the article entitled “Reduction of Data Pulse Voltage to 20 V by using ADD Scheme for ACPDPs” by M. Ishii et al., published in the document SID 99 DIGEST, pages 162-165, describes an addressing method of this type; documents FR 2 755 281 and EP 1 014 331 also describe an addressing method of this type; this method even allows separate addressing line by line; according to this method, during the address period for a group of lines, sustain periods for other groups of lines take place, resulting in “interleaving” of the periods and hence the name “interleaved” addressing system given to this method.

In a method of AWD type, comprising L groups of lines labelled 1, 2, . . . , j . . . , L:

for the group of lines labelled (j), the following succession occurs, . . . , address period T_{a-SF(i)-(j)}-sustain period T_{s-SF(i)-(j)} of a subfield SF₍ᵢ₎- . . . -address period T_{a-SF(i+k)-(j)}-sustain period T_{s-SF(i+k)-(j)} of the subfield SF₍ᵢ₊ₖ₎, etc.;

for another group of lines, labelled (j′), the following succession occurs: . . . , address period T_{a-SF(i′)-(j′)}-sustain period T_{s-SF(i′)-(j′)} of a subfield SF_{(i′)}- . . . -address period T_{a-SF(i′+k′)-(j′)}-sustain period T_{s-SF(i′+k′)-(j′)} of the subfield SF_{(i′+k′)}, etc.

In this AWD method, to avoid any interference between the groups of lines, two address operations must never occur simultaneously; there is therefore a fundamental constraint called “coherence” constraint: whatever i, i′ (including i=i′), j and j′ are, no address period T_{a-SF(i)-(j)} for a group of lines j must overlap an address period T_{a-SF(i′)-(j′)} for another group of lines j′.

Moreover, as in the case of the ADS method, it is important for all the lines or groups of lines of the panel to have the same series of subfields and, over the duration of a frame, it is important for the address method to be able to address all the subfields at all the groups of lines: thus, between the start of the first subfield engaged in a frame and the end of the final subfield engaged in this same frame, the total elapsed duration must not exceed the duration of a frame.

One advantage of this AWD method is that, during an image scan period or the duration of a frame, the overall time devoted to addressing is much shorter than in the first method, thereby making it possible for the sustain time, and therefore the overall brightness of the panel, to be proportionally increased. One difficulty in implementing this method lies in the sequencing of the address periods, which must be established so as to avoid any interference between various groups of lines.

The article entitled “New Drive System for PDPs with improved Image quality: Plasma Al” by M. Kasahara et al., published in SID 99 DIGEST on pages 158-161 discloses an improvement of the ADS method, allowing the “peak brightness” of the images displayed by the panel to be substantially improved; according to this improvement, the number of subfields is varied according to the average brightness of the image to be displayed:

when the average brightness is low, a small number of subfields, for example 8, is used;

when the average brightness is high, a larger number of subfields, for example 12, is used, so as to limit the risk of “contouring” without significantly impairing the brightness level.

This method of addressing with a dynamically variable number of subfields is easy to implement within the context of ADS-type methods, in the absence of coherence constraint, since the change in the number of subfields affects, straight away and for the entire panel, the succession: . . . , [T_{a-SF(i)}-T_{s-SF(i)} of a subfield SF₍ᵢ₎]-[T_{a-SF(i+1)}-T_{s-SF(i+1)} of the next subfield SF₍ᵢ₊₁₎], etc.

However, it proves to be very difficult to meet the coherence constraint specific to AWD methods when it is desired to vary the number of subfields dynamically when an AWD-type scanning method is used.

The aim of the invention is to remedy this difficulty.

For this purpose, the subject of the invention is a scanning method for pixel control signals, the pixels being located at the intersections of column electrodes and row electrodes in a panel for displaying images coming from a source,

in which column signals are addressed simultaneously and selectively at the column electrodes,

in which, the row electrodes being grouped together in groups of at least one line and of at most half of the lines of the panel, line signals are successively addressed at each group of lines of the said panel,

in which the said signals are staggered over a succession of frames T of duration T_{T} synchronized with the source of images to be displayed,

in which each frame comprises a succession of subfields,

in which each subfield has a period Tₐ for addressing line and column signals suitable for setting a pixel in the on or off state, followed by a period Tₛ of line and column sustain signals suitable for keeping the said element in the said on or off state,

in which, during the period T_{T} of a frame comprising the said succession of subfields and for each pixel of the panel, the number of subfields having an address period turning the said element on is varied according to the brightness of the point corresponding to this pixel in the image to be displayed,

in which the sequencing of the address periods for each of the subfields making up one frame is established so that, over the period T_{T} of this frame:

all the subfields of the same frame are addressed only once at each group of lines,

any overlap between them of the address periods for these subfields is avoided, characterized in that:

with the subfields divided into at least two subframes ST1, ST2, . . . , comprising g1, g2, . . . subfields respectively and

with the said sequencing of the address periods being established so that, over the execution of the g1, g2 subfields of each subframe ST1, ST2, all the subfields of this subframe are addressed only once at each group of lines, each frame consists of at least one subframe chosen from the said subframes ST1, ST2, . . .

One way of avoiding any mutual overlapping of the address periods in the sequencing of these periods is described in the document FR 2 755 281, for example on page 14, lines 9 to 32, with reference to FIG. 4 of that document.

Furthermore, as that document teaches for improving the brightness when an AWD-type scanning method is used, it is preferable to maximize the imbrication of the address periods for the various subfields so as to minimize any “dead time” between the end of the sustain period T_{s-SF(i)-(j)} of a subfield SF₍ᵢ₎ and the start of the address period T_{a-SF(i+k)-(j)} of the next subfield SF₍ᵢ₊ₖ₎ for any group of lines, for example labelled (j); in other words, it is preferable for the sequencing and the duration of the address periods of the subfields to be established so that, for each subfield SF, its total duration is as close as possible to the sum Tₐ+Tₛ of its address period and its sustain period; since the address periods Tₐ are in general relatively short compared with the sustain periods Tₛ, this condition amounts to stating that, for each group of at least one line, the sum of the periods Tₛ of the various subfields is as close as possible to the duration T_{T} of a frame; in practice, to obtain a high brightness, it is preferable for this sum to be greater than 0.7×T_{T}.

The invention may also have one or more of the following features:

the number of subframes ST1, ST2, etc. constituting a frame is varied during display;

the durations of execution of the said subframes are equal.

The subject of the invention is also the use of the method according to the invention for adjusting the brightness of the said panel.

The invention may therefore also have one or more of the following features:

the said brightness adjustment is effected automatically according to the average brightness of the image to be displayed;

the said brightness adjustment is effected automatically according to an internal process for controlling the electrical power consumed by the said panel.

The subject of the invention is also a plasma display panel comprising a system for implementing this method and for its use.

The number of brightness coding bits is thus varied continuously according to the requirements in terms of grey scales definition and/or overall brightness of the screen, and/or picture quality; the brightness may thus be coded, without distinction, over g1, g2, . . . bits, or any sum of these numbers g1, g2 corresponding to any one of the possible combinations of these subframes making up a frame.

Conventionally, the circumstances leading to the change in the number of coding bits may also result from an external command, for example a brightness adjustment by the panel's user; they may also result from an internal panel operation process, for example a power control process.

The invention therefore lies essentially:

1) in dividing the set of subfields SF₀, SF₁, . . . , SF₍ᵢ₎, SF₍ᵢ₊₁₎, . . . , SFₙ₋₁ into at least two subsets or subframes ST1, ST2, . . . of subfields;

2) in a suitable sequencing of the address periods so that all the address periods for the subfields of the same subframe ST1 and for all the groups of lines of the screen are executed over a time T_{ST1} specific to the subframe; the same applies to the other subframes ST2, etc.

Thus, for a general display mode based on twelve coding bits b₀, b₁, . . . , bᵢ, . . . , b₁₁ of the brightness signal for the pixels of an image to be displayed, which would, according to the invention, be divided into three groups in the following manner:

subframe ST1: b₀, b₁, b₂, b₃,

subframe ST2: b₄, b₅, b₆, b₇,

subframe ST3: b₈, b₉, b₁₀, b₁₁, over each group of lines of the display screen, the brightness bits are addressed by respecting the order of the subframes, for example firstly the bits of the subframe ST1 for all the groups of lines, then the bits of the subframe ST2, again for all the groups of lines, and finally the bits of the subframe ST3, again for all the groups of lines, it being possible for the bit addressing order to be varied, of course, from one group of lines to another within the same subframe ST1, ST2 or ST3.

According to the invention, the groups of lines are therefore addressed by subframes: the addressing of a bit belonging to a new subframe starts only when all the address periods for all the bits of the previous subframe have been completed.

If T_{ST1}, T_{ST2}, T_{ST3} are the respective durations of the subframes ST1, ST2, ST3 in the 12-bit display mode and if T_{T} corresponds to the duration of an identical frame for all the display modes (duration generally less than or equal to 20 ms), then T_{ST1}+T_{ST2}+T_{ST3}=T_{T}.

In the 12-bit display mode, the images are therefore displayed according to the following sequencing for one complete frame:

over T_{ST1}, all the subfields of the subframe ST1 are addressed at all the groups of lines; then

over T_{ST2}, all the subfields of the subframe ST2 are addressed at all the groups of lines; and finally

over T_{ST3}, all the subfields of the subframe ST3 are addressed at all the groups of lines.

This sequencing specific to the invention allows the number of subfields or the number of grey scale bits during display to be easily changed without losing the address coherence specific to the AWD method, that is to say without any risk of the address periods of groups of lines overlapping.

Thus, to switch from the above 12-bit display mode to another display mode, for example 8 bits based on the four bits of the first subframe ST1 and on the four bits of the second subframe ST2, the possible duration of illumination of the pixels of a group of lines, that is to say the duration of a frame, is then divided no longer over twelve subfields but only over four subfields of the subframe ST1 and the four subfields of the subframe ST2; for a complete frame, the images are then displayed according to the following new sequencing:

over T′_{ST1}, all the subfields of the subframe ST1 are addressed at all the groups of lines; and then

over T′_{ST2}, all the subfields of the subframe ST2 are addressed at all the groups of lines.

Since the number of bits decreases, T′_{ST1}>T_{ST1} and T′_{ST2}>T_{ST2}; T′_{ST1} and T′_{ST2 are chosen so as to satisfy the equation T′}_{ST1}+T′_{ST2}=T_{T}.

By dividing the duration of a frame over only 8 bits instead of 12:

the duration of each subfield of the subframe ST1 is increased by a same factor T′_{ST1}/T_{ST1}>1; and

the duration of each subfield of the subframe ST2 is increased by a same factor T′_{ST2}/T_{ST2}>1.

The brightness of the panel is thus increased.

Since the sequencing of the various periods, especially the address periods, remains unchanged within each remaining subframe ST1, ST2, this change in division does not destroy the coherence of the sequencing specific to the AWD method; by dividing the set of subfields into subframes, it becomes particularly simple for the number of subfields to be dynamically modified in an AWD-type addressing method.

Preferably, the duration of the eight subfields is increased in the same proportion so as to maintain the relative weight of the bits of the previous display mode; we then have the equation T′_{ST1}/T_{ST1}=T′_{ST2}/T_{ST2}.

Therefore, overall:

T′_{ST1}=T_{T}×[T_{ST1}/(T_{ST1}+T_{ST2})]

T′_{ST2}=T_{T}×[T_{ST2}/(T_{ST1}+T_{ST2})].

It is now possible to switch from the above 8-bit display mode to another display mode, for example one with only four bits based on the four bits of the first subframe ST1; for a complete frame, the images are therefore displayed with a new sequencing in which all the subfields of the subframe ST1 are addressed at all the groups of lines over T″_{ST1}=T_{T}.

Thus, by dividing the duration of a frame over only four bits, the duration of each subfield of the subframe ST1 is increased by a same factor T″_{ST1}/T′_{ST1}>1 without destroying the coherence of the sequencing specific to the AWD method.

The invention applies no matter what the number of subframes and also no matter what the number of brightness coding bits, provided that it is large enough for the frame to be able to be divided into subframes.

The invention will be more clearly understood on reading the description that follows, given by way of non-limiting example in the case of an AC plasma panel, and with reference to Tables I and II and to the appended figures in which:

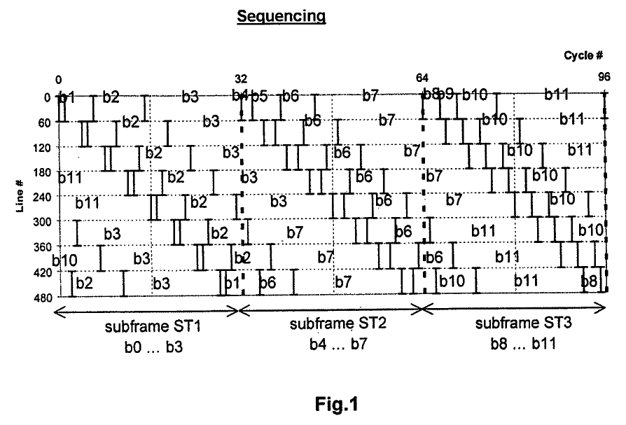

FIG. 1 illustrates the organization, into subframes according to the invention, of the sequencing of the address periods for a frame;

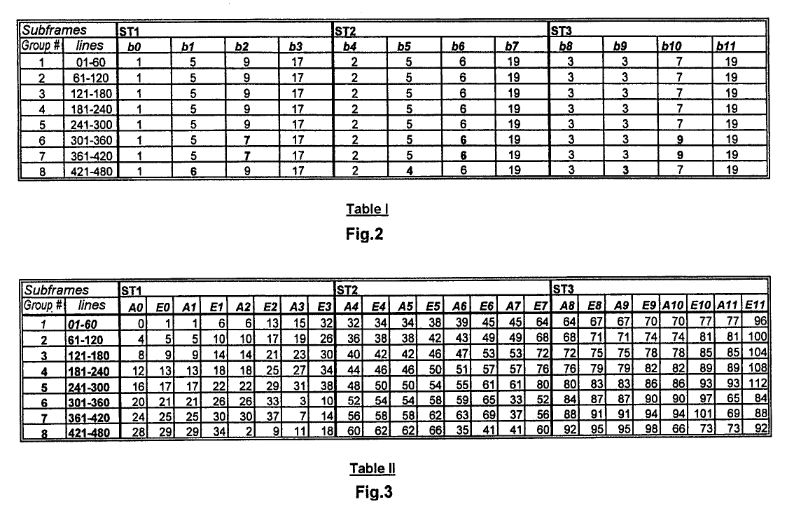

FIG. 2 corresponds to Table I; this table indicates the division of the subfields by subframes in accordance with the particular case of FIG. 1, and the maximum duration of each subfield b0, b1, . . . , b11 for each group of lines 1, 2, . . . , 8; and

FIG. 3 corresponds to Table II; this table indicates the instances at which the subfields of Table I start and end, using the sequencing according to the invention.

The description that follows relates to a method of driving an AC colour plasma panel comprising 409440 pixels divided between 480 lines and 853 columns; since each column is subdivided into three columns of primary colours, there are therefore 853×3=2559 columns of pixels to be controlled.

A plasma panel conventionally comprises two insulating plates each having at least one array of electrodes, one of column electrodes and the other of line electrodes, leaving between the plates a space containing a discharge gas; each pixel of the panel is formed by a cell positioned between the plates at each intersection of a column electrode of one plate and a row electrode or pair of row electrodes of the other plate; the cells may be separated from each other by barrier ribs; in the AC plasma panels, the arrays of electrodes are covered with a dielectric layer suitable for providing a “memory” effect; a protective layer, generally based on MgO, covers the arrays of electrodes or, when appropriate, the dielectric layers; the walls of the cells are partially covered with phosphors suitable for emitting visible light in the desired primary colour under the excitation of a luminous electrical discharge created between the electrodes.

Apart from the plasma panel described above, the installation furthermore includes an electronic system for supplying and addressing the electrodes of the panel, which is known per se and will not be described here in detail, except as regards the elements below relating to the invention.

Thus, the method of driving the panel is designed, in a manner known per se, to apply voltage signals between the electrodes suitable for causing or not causing discharges to occur in each cell, so as to make the phosphors of this cell emit or not emit, that is to say to turn the pixel on or not; the state—on or off—of each pixel of a line or group of lines is controlled by sending a suitable signal to the corresponding row electrode or electrodes and simultaneously sending a suitable signal to the electrode of the column at the intersection of which the said pixel is located; in the present case, the lines are grouped together in groups of 60 lines so as to obtain in total eight groups of lines; all the groups of lines are then scanned so as to control the state of all the pixels of the panel; the scan time must be less than the image refresh time, or frame duration; the frame duration is generally 20 ms for a 50 Hz video image source.

The brightness or grey scale gradation is conventionally implemented by temporal modulation of the light emission; for this purpose, the duration of a frame is divided into subfield periods; a subfield is generally called a “bit” by assimilation with the corresponding bit of the video word for controlling the brightness of a pixel; to obtain sufficient resolution in this gradation and to limit image defects, especially contouring, a sufficiently high number of subfields or bits, in this case n=12, is chosen.

Each subfield SF₀, SF₁, . . . , SF₁₁ or bit b₀, b₁, . . . , b₁₁ is assigned a duration T_{SF0}, T_{SF1}, . . . , T_{SF11} tailored in a manner known per se both to the best grey scale resolution and to the best picture quality.

According to the invention, these twelve subfields are then divided into three subframes ST1, ST2, ST3 in the following manner:

ST1=[SF₀, SF₁, SF₂, SF₃]

ST2=[SF₄, SF₅, SF₆, SF₇]

ST3=[SF₈, SF₉, SF₁₀, SF₁₁].

The “memory” effect specific to AC panels makes it possible, after each pixel of the same group of lines has been selectively turned on or not, using appropriate column and line signals (address signals), to keep the pixels of this line in the same state—either on or off—by sending a suitable identical signal simultaneously to all these pixels (sustain signal); thus, since the sustain signal is identical for all pixels, the sustain periods for the various lines or groups of lines may overlap without any inconvenience; in contrast, it is obviously not the case with address periods!

It is therefore important to establish the sequencing of the address periods and therefore that of the subfields of each subframe ST1, ST2, ST3 so as to avoid any overlap; for this purpose, simulation means known per se are used in order to establish a possible sequencing without overlap of the address periods.

These simulation means make it possible for the values of the weights of the various subfields to be precisely determined.

If the subfield having the shortest duration, T_{SF0}, is assigned the value 1 in arbitrary units, called the “weight” of the subfield SF₀ or of the bit, i.e. T_{SF0}=1, then, for example:

for ST1: T_{SF0}=1; T_{SF1}=5; T_{SF2}=9; T_{SF3}=17;

for ST2: T_{SF4}=2; T_{SF5}=5; T_{SF6}=6; T_{SF7}=19;

for ST3: T_{SF8}=3; T_{SF9}=3; T_{SF10}=7; T_{SF11}=19.

The cumulative weights or durations of execution of these subframes are in this case the same and equal to 32; this configuration of subframes with the same durations or the same weights advantageously makes it possible to minimize the time taken between addressing a bit on a group of lines and addressing the same bit on the next group of lines, and thus limit a picture artefact (of the contouring type) manifested by a boundary between the various groups of lines.

Each subfield of a group of lines starts with an address period for the sixty lines of this group; if the duration of a frame T_{T} is set at 20 ms, and since there are 96 address cycles to be carried out during one frame [8 (groups of lines)×12 (subfields per frame)], an address period for 60 lines cannot exceed 20 ms/96=208 μs, something which is technically achievable using technical means known per se that will not be described here in detail.

According to the invention, it is important that, over the duration of a subframe ST1, ST2 or ST3, all the subfields of the same subframe be addressed only once for each group of lines.

FIG. 1 illustrates the sequencing obtained, with the number of the lines of the eight groups of lines plotted on the y-axis and the time divided into three subframes or 96 address cycles (unit of time) is plotted on the x-axis; it may therefore be seen that, according to the invention over the subframe ST1, all the subfields or bits b0, b1, b2, b3 specific to this subframe, of weights 1, 5, 9, 17 respectively, are addressed; the same applies to the other subframes ST2 and ST3.

FIG. 1 also shows that the construction of the scan leads to changes, from one group of lines to another, in the order of the subfields within each subframe ST1, ST2, ST3; these changes—in this case rotations—result, within the frame, a modification in the order of the subfields; this entails a few very slight variations in the actual duration of the subfields depending on the group of lines in question, the variations being clearly indicated in Table I.

Table I of the appended FIG. 2 gives, for each subfield (b0 to b7) and for each group of lines (1 to 8) the actual duration of the subfields of each subframe ST1, ST2, ST3; in all cases, the weight of each subfield SF₍ᵢ₎ must be reduced to the smallest of the weights of SF₍ᵢ₎ over the entire panel; thus, the actual weights of the subfields will be reduced to:

for the 6th and 7th groups of lines in the case of ST1: T_{SF0}=1; T_{SF1}=5; T_{SF2}=7; T_{SF3}=17;

for the 8th group of lines in the case of ST2: T_{SF4}=2; T_{SF5}=4, T_{SF6}=6; T_{SF7}=19;

for the 8th group of lines in the case of ST3: T_{SF8}=3; T_{SF9}=3; T_{SF10}=7; T_{SF11}=19.

This adjustment in the actual durations of the subfields according to the group of lines is made by judiciously choosing the location of the erase operation.

Table II of the appended FIG. 3 proposes a sequencing of these subfields and makes it possible to check the consistency of the sequencing proposed, subframe by subframe; if we consider that the arbitrary unit of time corresponds to an address period or “cycle” (at most 208 μs), this table indicates, for each group of lines, the instant at which the address period for a subfield starts (see the columns whose reference starts with A): a check is therefore made in this table that there is no overlap of the address periods within the frame and a fortiori within each subframe.

To ensure that there is a sufficiently uniform distribution of the weights of each subfield over the entire panel, it is also necessary to introduce “dead times” between the end of a subfield (end of its sustain period) and the start of the next subfield (start of the address period) over the same group of lines: Table II indicates, for each group of lines, the instant when the subfield ends (see the columns whose reference starts with E); the time possibly elapsing between this instant and that of the next subfield in the same group of lines (columns A) is a “dead time”; a check is made in this Table II that:

for each group of lines, the weight of each subfield is equal to the actual weight indicated in Table I;

the “dead time” of each frame remains less than 30% of the duration of this frame: the instant at which the last subframe (in this case E11, line 5) ends corresponds to 112 arbitrary units; this instant marks the end of a frame; thus, the duration T_{T} of a frame is equal to 112 arbitrary units; moreover, the sum of the weights of the subfields is approximately equal to 96 arbitrary units (Table II: sum of the “weights” of the same group of lines); the ratio of the sum of the periods Tₛ of the various subfields to the duration T_{T} of a frame is therefore equal to 96/112=0.86; this ratio is high enough to ensure that the panel has a high brightness; this brightness is further improved by the method according to the invention.

Using FIG. 1 and Table II, it is possible to deduce the instant (in arbitrary units) of the start and end of addressing each subframe for each group of lines; the results are given in Table III below.

TABLE III
Instants of the first and last subframe
address operations

| Sub- | | | | | | |
|---|---|---|---|---|---|---|
| frame | ST1 | | ST2 | | ST3 | |
| Group of | First | Last | First | Last | First | Last |
| lines | instant | instant | instant | instant | instant | instant |
| 1 | 0 | 15 | 32 | 45 | 64 | 77 |
| 2 | 4 | 19 | 36 | 49 | 68 | 81 |
| 3 | 8 | 23 | 40 | 53 | 72 | 85 |
| 4 | 12 | 27 | 44 | 57 | 76 | 89 |
| 5 | 16 | 31 | 48 | 61 | 80 | 93 |
| 6 | 3 | 26 | 33 | 59 | 65 | 90 |
| 7 | 7 | 30 | 37 | 63 | 69 | 94 |
| 8 | 2 | 29 | 35 | 62 | 66 | 95 |

It may therefore be seen, according to the invention:

all the addressing operations for the subframe ST1 are carried out between the instant 0 and the instant 32;

all the addressing operations for the subframe ST2 are carried out between the instant 32 and the instant 64;

all the addressing operations for the subframe ST3 are carried out between the instant 64 and the instant 96.

In arbitrary units, the duration of each subfield is: T_{ST1}=T_{ST2}=T_{ST3}=32; thus T_{ST1}+T_{ST2}+T_{ST3}=T_{T}=96.

Thus, according to the invention, all the subfields of the same subframe are addressed only once at each group of lines over the duration of this subframe; between the start of the first subfield engaged in a subframe and the start of the last subfield engaged in this last subframe, the total elapsed time does not exceed the duration of this subframe.

The use of all or part of the sequencing of FIG. 1 driving the plasma panel will now be described.

All of this sequencing may firstly be used conventionally by dividing the duration of a frame over the twelve subfields of FIG. 1, that is to say over the three subframes ST1-ST2-ST3; this first display mode therefore corresponds to a 12-bit coding of the brightness.

The electronic system for supplying and addressing the electrodes then converts, in a manner known per se, the video input signal of the installation into 12-bit video words (b₀, b₁, b₂, . . . , b₍ₙ₋₁₎, each word being associated with one pixel of the panel and having a numerical value that depends on the brightness to be displayed by this pixel; using the method and the sequencing described above, each word is addressed to the pixel associated with it so as to obtain the temporal modulation of the light emission from this pixel; at the end of the duration of a frame, a complete image is then displayed on the panel; the succession of frames ST1-ST2-ST3, ST1-ST2-ST3, ST1-ST2-ST3, etc. leads to the refreshing and to the execution of the image at a frequency of 50 Hz.

During execution of the image, it may be useful to decrease the number of pixel brightness coding bits; by virtue of the invention, it is possible to very easily switch from the above 12-bit coding to a coding corresponding to any combination of the number of subfields of the subframes ST1, ST2 and/or ST3; apart from 12 bits, possible combinations result in four or eight brightness coding bits.

To reduce the number of brightness coding bits during execution of the image, the duration of a frame is then divided into two subframes (8-bit coding), or into a single subframe (4-bit coding) while maintaining, within each subframe, the sequencing of FIG. 1; a frame has no more than 8, or even 4, subfields:

in the case of 8-bit coding, a frame then corresponds to the succession ST1-ST2 or ST2-ST3 or ST1-ST3;

in the case of 4-bit coding, a frame then corresponds to a single subframe ST1, ST2 or ST3.

If it is desired to keep the same refresh rate, that is to say the same frame duration, the duration of the subfields and of the subframes are extended in the same proportions so as to “fill” the entire frame and to maintain the relative weight of the remaining bits.

The electronic system for supplying and addressing the electrodes then converts, in a manner known per se, the video input signal of the installation in 4-bit or 8-bit video words and addresses these words to the pixel associated with it and, after the duration of one frame, a complete image is then displayed on the panel.

The transitions from a 12-bit brightness coding display mode to a display mode having a smaller number of coding bits, and also the reverse transitions, are thus continuously carried out very easily during display.

Advantageously, the reduction in the number of bits during display allows the duration of the address periods and preferably that of the duration of the sustain periods to be increased, thereby allowing the brightness of the panel to be increased.

The invention has all the known advantages of the AWD-type methods, especially the advantage of a high brightness and a distribution over the entire frame of the electrical power consumed by the panel.

If the subfields are distributed sufficiently uniformly over the subframes, so that each subframe contains approximately as many high-weight subfields as low-weight subfields, the scanning method according to the invention allows the image defects relating to contouring to be reduced.

The invention applies whatever the number of subframes and also whatever the number of brightness coding bits, provided that it is high enough for the frame to be able to be divided into subframes.

Thus, if the entire frame comprises 14 subfields, so that the brightness coding may be carried out over 14 bits, in which the 14 subfields are divided into four subframes ST1, ST2, ST3 and ST4 comprising 2, 3, 4 and 5 subfields respectively, the possible brightness codings are, according to the invention, 2, 3, 4, 5, 6, 7, 8, 9, 10, 11, 12 and 14 bits; codings having the same number of bits may be achieved by various combinations of subframes: for example, the combination ST1-ST2 results in the same number of bits as the subframe ST4 alone; the possibility of choosing from several codings having the same number of bits advantageously makes it possible to obtain a progressive adjustment of the brightness.

The present invention has been described with reference to an AC plasma panel, but it applies to other types of plasma panels and to any matrix display panel requiring scanning to control the pixels thereof.

Thus, the invention also applies to the driving of plasma-addressed liquid-crystal (PALC) panels and to the driving of reflective liquid-crystal-on-silicon (LCoS) matrices.

1. Scanning method for pixel control signals, the pixels being located at the intersections of column electrodes and row electrodes in a panel for displaying images coming from a source,
in which column signals are addressed simultaneously and selectively at the column electrodes,
in which, the row electrodes being grouped together in groups of at least one line and of at most half of the lines of the panel, line signals are successively addressed at each group of lines of the said panel,
in which the said signals are staggered over a succession of frames T of duration T_{T} synchronized with the source of images to be displayed,
in which each frame comprises a succession of subfields,
in which each subfield has a period Tₐ for addressing line and column signals suitable for setting a pixel in the on or off state, followed by a period Tₛ of line and column sustain signals suitable for keeping the said element in the said on or off state,
in which, during the period T_{T} of a frame comprising the said succession of subfields and for each pixel of the panel, the number of subfields having an address period turning the said element on is varied according to the brightness of the point corresponding to this pixel in the image to be displayed,
in which the sequencing of the address periods for each of the subfields making up one frame is established so that, over the period T_{T} of this frame:
all the subfields of the same frame are addressed only once at each group of lines,
any overlap between them of the address periods for these subfields is avoided,
characterized in that:
with the subfields divided into at least two subframes ST1, ST2, . . . , comprising g1, g2, . . . subfields respectively and
with the said sequencing of the address periods being established so that, over the execution of the g1, g2 subfields of each subframe ST1, ST2, all the subfields of this subframe are addressed only once at each group of lines, each frame consists of at least one subframe chosen from the said subframes ST1, ST2, . . .

2. Method according to claim 1, characterized in that the sum of the periods Tₛ of the various subfields is greater than 0.7×T_{T}.

3. Scanning method according to claim 1 or 2, characterized in that the number of subframes ST1, ST2, . . . constituting a frame is varied during display.

4. Method according to any one of the preceding claims, characterized in that the durations of execution of the said subframes are equal.

5. Use of the method as claimed in either of claims 3 and 4 for adjusting the brightness of the said panel.

6. Use according to claim 5, characterized in that the said brightness adjustment is carried out automatically depending on the average brightness of the image to be displayed.

7. Use according to claim 5, characterized in that the said brightness adjustment is carried out automatically according to an internal process for controlling the electrical power consumed by the said panel.

8. Plasma display panel, characterized in that it includes a system for implementing the method according to any one of claims 1 to 4 or for the use of this method according to any one of claims 5 to 7.
